(19) United States
(12) Patent Application Publication
(10) Pub. No.: US 2022/0262185 A1
(43) Pub. Date: Aug. 18, 2022

(54) Identity Determination Using Biometric Data

(71) Applicant: Evolv Technologies, Inc., Waltham, MA (US)

(72) Inventors: Michael Ellenbogen, Wayland, MA (US); Steven Morandi, North Andover, MA (US); Owais Hassan, Andover, MA (US); Matthew Belley, Chelmsford, MA (US); Matthew Levine, Waltham, MA (US)

(21) Appl. No.: 17/673,481

(22) Filed: Feb. 16, 2022

Related U.S. Application Data
(60) Provisional application No. 63/149,912, filed on Feb. 16, 2021.
(60) Provisional application No. 63/285,787, filed on Dec. 3, 2021.

(51) Int. Cl. G07C 9/25; G07C 9/27

(52) U.S. Cl. CPC G07C 9/253; G07C 9/27

(57) ABSTRACT

A method for determining an identity of an individual is provided. The method can include receiving a first unique identifier from a first device associated with a first individual. The method can also include receiving biometric data associated with the first individual. The method can further include determining an identity of the first individual by filtering a database to generate a set of candidate identities. The database can include associations of a registered identity, a registered unique identifier, and registered biometric data for each of a plurality of individuals. Determining the identity of the first individual can also include comparing the received biometric data to registered biometric data in the database of at least one candidate identity, and selecting the identity from the set of candidate identities. The method can also include providing the identity. Related systems, apparatuses, and computer-readable mediums are also provided.

### CROSS REFERENCE TO RELATED APPLICATION

This application claims the benefit of and priority under 35 U.S.C. § 119 to U.S. Provisional Patent Application No. 63/149,912 filed Feb. 16, 2021 and to U.S. Provisional Patent Application No. 63/285,787 filed Dec. 3, 2021, the entire contents of each are hereby expressly incorporated by reference herein.

### TECHNICAL FIELD

The subject matter described herein relates to personnel checkpoint security screening systems with integrated authorization (e.g., credential verification, ticketing, and the like) and biometric data processing for identity determination.

### BACKGROUND

Checkpoint security systems attempt to prevent any threats or potentially dangerous situations from arising or entering a protected zone. For example, airport security attempts to prevent threats or potentially dangerous situations from arising or entering the country and the airport. Similar checkpoint systems can be utilized in a wide variety of applications such as at sporting events, music venues, schools, government buildings, and other places where a secure environment is desired. Some existing radio frequency (RF) imaging systems (such as those utilized by airport security for passenger screening) are large, expensive, and require individuals to remain stationary while an antenna rotates around the stationary individual to capture an image.

Some existing inspection systems, such as walkthrough metal detectors, can include coils to generate and measure changes in a magnetic field caused by magnetic or conductive materials (e.g., metallic) passing through the magnetic field. These existing inspection systems can be capable of measuring for metallic objects passing through a threshold but can lack any ability to distinguish personal items such as a cell phone, laptop, keys, belt buckle, and the like from threats, such as fire arms or improvised explosive devices.

Similarly, some ticketing or similar credential systems require a ticket holder to hand a ticket or other form of identification to a ticket taker, who verifies the ticket (and/or other credentials, identify documents, and the like). Some ticketing or similar credential systems require an individual to stop their forward motion to present a ticket to a stationary barcode scanner and/or turnstile. Such processing is slow and limits throughput of individuals passing through the checkpoint.

Facial recognition systems can be used to determine an individual's identity. Image data of an object or individual can be captured by a sensor coupled to a processing system configured to identify the object or individual. The processing system can utilize a database or similar data source containing reference data of objects and individuals to determine that the acquired sensor data matches the reference data. In this way, the identity of the object or individual can be confirmed by the processing system.

Facial recognition can be computationally intensive and require specialized computer equipment and processing techniques to adequately determine object or individual identities in real-time or near real-time. Rapid processing of facial recognition data is important to facilitate notification and alerts in a timely manner to maintain safety and security in environments containing large numbers of objects or individuals.

### SUMMARY

In one aspect, a method is provided. In an embodiment, the method can include receiving a first unique identifier and a second unique identifier. The first unique identifier can be received from a first device associated with a first individual. The second unique identifier can be received from a second device associated with a second individual. The method can also include receiving biometric data associated with the first individual. The method can further include determining an identity of the first individual. Determining the identity can include filtering a database using at least the first unique identifier and the second unique identifier to generate a set of candidate identities. The database can associate a registered identity, a registered unique identifier, and registered biometric data for each of a second plurality of individuals. The first plurality of individuals can form a part of the second plurality of individuals. Determining the identity can also include comparing the received biometric data to the registered biometric data of at least one candidate identity in the set of candidate identities. Determining the identity can further include selecting, based on the comparing, the identity from the set of candidate identities. The method can also include providing the identity of the first individual.

In some variations, one or more features disclosed herein including the following features may optionally be included in any feasible combination. For example, the first unique identifier and the second unique identifier can be received by a proximity sensor having a sensor range characterizing a geographic area. The first individual and the second individual can form part of a first plurality of individuals. The first plurality of individuals can be within the geographic area. The proximity sensor can include an infrared camera, a thermal camera, an ultrasonic distance sensor, a video camera, an electro-optical camera, a surface map camera, a depth map camera, a short range wireless data transmission sensor, a radio frequency identification reader, and/or a barcode reader.

The method can further include filtering the database based on a time window characterizing a time that the first plurality of individuals are expected to be within the geographic area of the proximity sensor. The first unique identifier can include a unique identifier associated with a computing device of the individual, an international mobile equipment identity number of the computing device, a media access control address of a network interface card of the computing device, and/or a token associated with the individual and generated by the computing device. The biometric data can characterize a facial image or a fingerprint.

Providing the identity can include authorizing, using the determined identity, the first individual for access into a restricted area. Authorizing the first individual can include accessing a credential associated with the identity and authorizing the credential. The accessing can include requesting the credential from a ticketing system.

Providing the identity can include providing the identity to a security screening sensor system and modifying operation of the security screening sensor system based on the determined identity. The security screening sensor system can include an entryway. The security screening sensor system can also include at least one transmitter configured to transmit radar signals and/or a magnetic field to interrogate objects and/or people passing through the entryway. The security screening sensor system can also include at least one sensor configured to receive radar signals and/or measure the magnetic field. The security screening sensor system can also include a data processor configured to receive data characterizing the received radar signals and/or measured magnetic field and determine a threat level associated with the object and/or person passing through the entryway.

Modifying operation of the security screening system can include changing a detection threshold for detecting a threat passing through the entryway, changing a threat classification algorithm, changing a transmit or receive level of the security screening system, wherein the threat includes a firearm, a blade, an explosive, and/or a weapon.

The method can also include determining a security status of the first individual and modifying operation of the security screening system based on the determined security status. The security status of the first individual can indicate an increased likelihood the first individual will pass a security screening check or a decreased likelihood the first individual will pass the security screening check. The identity can characterize a name, a very important person (VIP) label, a person of interest status, a known law enforcement status, an employee number, a membership number, a social security number, and/or a ticket number. Providing the identity can include unlocking a gate to enable entry by the first individual to a restricted area.

In another aspect, a system is provided. In an embodiment, the system can include a memory storing computer-executable instructions and a data processor communicatively coupled to the memory. The data processor can be configured to execute the computer-executable instructions stored in the memory, which when executed can cause the data processor to perform operations including receiving a first unique identifier and a second unique identifier. The first unique identifier can be received from a first device associated with a first individual. The second unique identifier can be received from a second device associated with a second individual. The operations can also include receiving biometric data associated with the first individual. The operations can further include determining an identity of the first individual. Determining the identity can include filtering a database using at least the first unique identifier and the second unique identifier to generate a set of candidate identities. The database can associate a registered identity, a registered unique identifier, and registered biometric data for each of a second plurality of individuals. The first plurality of individuals can form a part of the second plurality of individuals. Determining the identity can also include comparing the received biometric data to the registered biometric data of at least one candidate identity in the set of candidate identities. Determining the identity can further include selecting, based on the comparing, the identity from the set of candidate identities. The operations can also include providing the identity of the first individual.

In some variations, one or more features disclosed herein including the following features may optionally be included in any feasible combination. For example, the first unique identifier and the second unique identifier can be received by a proximity sensor having a sensor range characterizing a geographic area. The first individual and the second individual can form part of a first plurality of individuals. The first plurality of individuals can be within the geographic area. The proximity sensor can include an infrared camera, a thermal camera, an ultrasonic distance sensor, a video camera, an electro-optical camera, a surface map camera, a depth map camera, a short range wireless data transmission sensor, a radio frequency identification reader, and/or a barcode reader.

The instructions can further cause the data processor to perform operations including filtering the database based on a time window characterizing a time that the first plurality of individuals are expected to be within the geographic area of the proximity sensor. The first unique identifier can include a unique identifier associated with a computing device of the individual, an international mobile equipment identity number of the computing device, a media access control address of a network interface card of the computing device, and/or a token associated with the individual and generated by the computing device. The biometric data can characterize a facial image or a fingerprint.

The instructions for providing the identity can further cause the data processor to perform operations including authorizing, using the determined identity, the first individual for access into a restricted area. The instructions for authorizing the first individual can cause the data processor to perform operations including accessing a credential associated with the identity and authorizing the credential. The accessing can include requesting the credential from a ticketing system.

The instructions for providing the identity can further cause the data processor to perform operations including providing the identity to a security screening sensor system and modifying operation of the security screening sensor system based on the determined identity. The security screening sensor system can include an entryway. The security screening sensor system can also include at least one transmitter configured to transmit radar signals and/or a magnetic field to interrogate objects and/or people passing through the entryway. The security screening sensor system can also include at least one sensor configured to receive radar signals and/or measure the magnetic field. The security screening sensor system can also include a data processor configured to receive data characterizing the received radar signals and/or measured magnetic field and determine a threat level associated with the object and/or person passing through the entryway.

The instructions for modifying the operation of the security screening system can include changing a detection threshold for detecting a threat passing through the entryway, changing a threat classification algorithm, changing a transmit or receive level of the security screening system, wherein the threat includes a firearm, a blade, an explosive, and/or a weapon.

The instructions can further cause the data processor to perform operations including determining a security status of the first individual and modifying operation of the security screening system based on the determined security status. The security status of the first individual can indicate an increased likelihood the first individual will pass a security screening check or a decreased likelihood the first individual will pass the security screening check. The identity can characterize a name, a very important person (VIP) label, a person of interest status, a known law enforcement status, an employee number, a membership number, a social security number, and/or a ticket number. Providing the identity can include unlocking a gate to enable entry by the first individual to a restricted area.

In another aspect, a computer-readable medium is provided. In an embodiment, the computer readable medium can store computer-executable instructions, which when executed by a data processor cause the data processor to perform operations. The operations can include receiving a first unique identifier and a second unique identifier. The first unique identifier can be received from a first device associated with a first individual. The second unique identifier can be received from a second device associated with a second individual. The operations can also include receiving biometric data associated with the first individual. The operations can further include determining an identity of the first individual. Determining the identity can include filtering a database using at least the first unique identifier and the second unique identifier to generate a set of candidate identities. The database can associate a registered identity, a registered unique identifier, and registered biometric data for each of a second plurality of individuals. The first plurality of individuals can form a part of the second plurality of individuals. Determining the identity can also include comparing the received biometric data to the registered biometric data of at least one candidate identity in the set of candidate identities. Determining the identity can further include selecting, based on the comparing, the identity from the set of candidate identities. The operations can also include providing the identity of the first individual.

### DESCRIPTION OF DRAWINGS

FIG. 1 is a system block diagram illustrating an example digital threshold system that is capable of streamlining a visitor's experience and improving throughput of security and ticketing checkpoint operation;

FIG. 2 is an illustration of an example visitor screening with integrated authorization (e.g., ticketing, credential verification) process that includes the digital threshold system and two beacons;

FIG. 3 illustrates another example process diagram of an example visitor screening with integrated authorization process;

FIG. 4 is another example process diagram of an example visitor screening with integrated authorization process;

FIGS. 5-6 illustrate examples of a digital threshold system as described in some embodiments herein;

FIG. 7 illustrates the path of an individual through a facility (e.g., stadium) configured with a digital threshold system as described herein during a typical visit and how some implementations of the current subject matter can streamline the individual's visit from approach to exit;

FIGS. 8-9 illustrate embodiments of data flows between various sensors, computing devices (e.g., personal electronic devices), remote server, and third party services of the digital threshold system described herein;

FIG. 10 is a system block diagram of an embodiment of a digital threshold system for identifying an object or individual based on proximity data;

FIG. 11 is a process block diagram of an embodiment of a process for identifying an object or individual based on proximity data using the digital threshold system of FIG. 10; and

FIG. 12 is a data flow diagram describing an example embodiment for identifying an object or individual based on proximity data using the digital threshold system of FIG. 10 performing the process of FIG. 11.

Like reference symbols in the various drawings indicate like elements.

### DETAILED DESCRIPTION

Security and ticketing are major operational bottlenecks for venues such as music venues, sports venues, office buildings, military bases, and the like. These bottlenecks create difficulty and inconvenience for the visitors to the venue, as well as for the operators responsible for maintaining safety and ensuring that visitors have the appropriate credentials (e.g., ticket, identification, and the like). For example, a sporting event at a stadium can require thousands of attendees to be screened for dangerous and prohibited items as well as have their tickets to the event collected and/or verified (e.g., their presence needs to be authorized). These steps take time and are low throughput, resulting in attendees experiencing long lines, waiting periods, and the like. In addition, venue operators may require additional staff to ensure they have capacity to process a large amount of attendees in a short amount of time. Other operational bottlenecks can include parking, wayfinding (e.g., attendees searching for a specific location, such as a restroom, vendor, assigned seat, entry gate, and the like), retail (ordering of and payment for merchandise), and high-traffic events (such as occurs at a venue restroom during “half-time” of a game, at exits of the venue at the end of the event, and the like). Each of these bottlenecks similarly result in attendee and venue operator inconvenience, long lines, and long waiting periods.

Accordingly, some implementations of the current subject matter can include a digital threshold system enabling a streamlined visitor experience including combining a high-throughput authorization (e.g., ticketing, credential verification, and the like) step with security screening. By combining a high-throughput authorization step with security screening, attendee and venue operator convenience can be improved, the length of lines can be reduced, and attendee waiting periods can be reduced. Moreover, the combined high-throughput authorization step with security screening can result in operational efficiencies, which can reduce venue operator costs and logistics requirements. Some implementations can include attendee location-aware technology that can reduce other bottlenecks such as parking, wayfinding, retail, exit/restroom wait times, and the like. Location-aware technology can be aware of each attendee's location and enable the provision of contextually relevant information to the attendee and/or venue operator based on the attendee location.

The use of proximity data acquired via sensors as individuals approach the digital threshold systems can enhance identification and security authorization of individuals. The digital threshold system can be configured to determine identification and security authorization of individuals by generating a set of candidate objects or individuals for use in querying a gallery of reference information (e.g., reference facial information). Rather than querying the database for a match of image data associated with each individual object or person, some implementations of the current subject matter can provide faster processing and more rapid identification of objects and individuals by first acquiring information regarding electronic devices of individuals that are proximal to a sensor and filtering a gallery of facial information based on the acquired information. The larger gallery of facial information can be filtered based on the electronic identity information to produce a smaller set of facial information that is to be searched. Such an approach can reduce the number of comparisons that needs to be performed in order to match facial information and determine an identity of an individual. As a result, the likelihood of false matches can be reduced and the accuracy of the facial recognition processing can be improved.

In some implementations, a digital threshold system can include a proximity sensor, a sensor, a computing device, and a database. Proximity data of an object or individual can be acquired via the proximity sensor and provided to a processor of the computing device. The processor can query the database based on unique identifiers included in the proximity data to determine a set of candidate objects or individuals corresponding to the unique identifiers from all objects and individuals in the database. The processor can compare the set of candidate objects and individuals to data acquired via the sensor to confirm or verify the identity of the objects and individuals corresponding to those for which the proximity data was received. Based on a positive match, the processor can confirm the object or individual is properly identified as the object or individual included in the database. If a negative match occurs, the processor can generate an alert or notification to indicate that the object or individual is not identified as the object or individual in the database.

Advantages of some implementations of the digital threshold system described herein can include higher throughput of individuals being evaluated, reduced incidence of false alarms due to more accurate discrimination of objects or individuals, and reduced stress levels and improved emotional response for individuals being evaluated using the digital threshold system provided herein. In addition, some implementations of the digital threshold system can more accurately distinguish objects and individuals in groups based on proximity data associated with each individual. The data that is collected, processed, and generated by the improved facial recognition system can also be used within the context of other security-focused operations such as notification to system operators of individuals and objects who do not match a global registry or database of individuals or objects, training exercises for facial recognition system operators or supervisors, as well overall process improvement of security procedures which may occur prior to or after individuals or objects are screened or evaluated using the digital threshold system described herein.

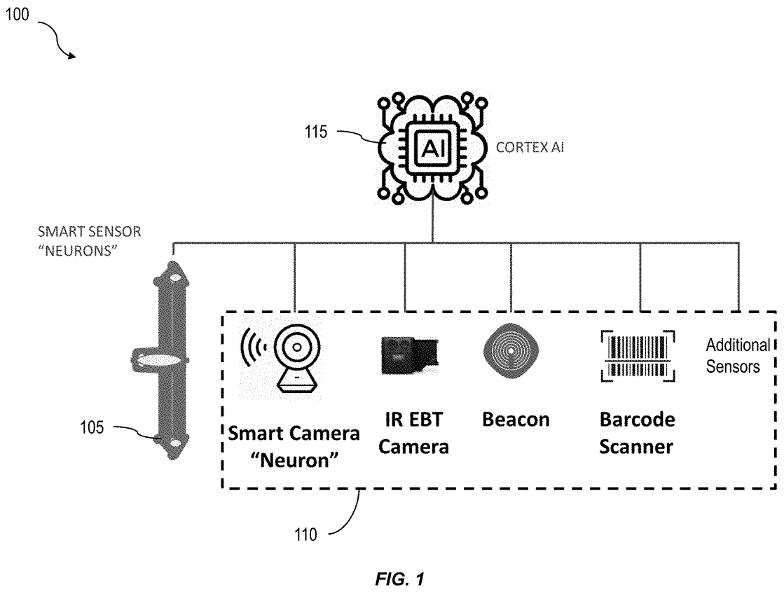

FIG. 1 is a system block diagram illustrating an example digital threshold system 100 that is capable of streamlining a visitor's experience and improving throughput of security and ticketing checkpoint operation. The system 100 can include an inspection system 105, one or more additional sensors 110, and a remote server 115. The inspection system 105 can perform security screening of venue attendees and can include, for example, a radio frequency (RF) imaging system, walkthrough metal detector (e.g., portal), and the like. The inspection system 105 can provide an entryway (e.g., a portal or other threshold) through which a person (or people) undergoing screening pass through. As they pass through, they are screened for threats or contraband, for example, by performing RF imaging of the individual, or sensing for metallic objects such as firearms. In some implementations, the inspection system 105 can provide near immediate feedback to a security guard as to whether or not a potential threat or contraband is detected.

Sensors 110 can include smart cameras, infra-red cameras, beacons (using wireless technology such as NFC, RFID, Bluetooth, and the like), barcode scanner, and other sensors. A smart camera or intelligent camera is a machine vision system which, in addition to image capture circuitry, is capable of extracting application-specific information from the captured images, along with generating event descriptions or making decisions that are used in an intelligent and automated system. Smart cameras are suited for applications where several cameras must operate independently and often asynchronously, or when distributed vision is required (e.g., multiple inspection or surveillance points).

Inspection system 105 and sensors 110 can operate in a coordinated fashion to streamline a visitor's experience including performing an integrated security screening and authorization.

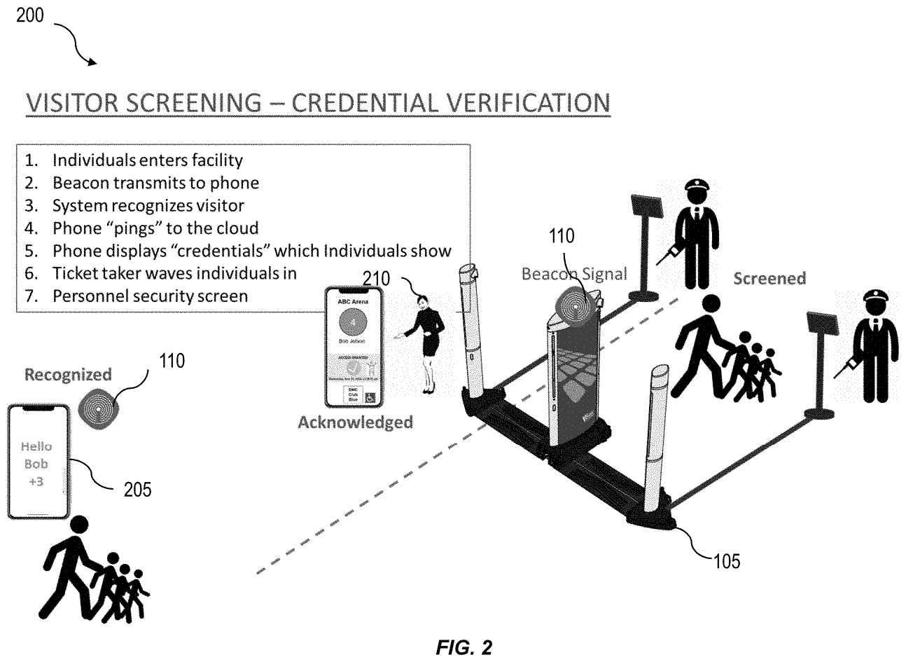

FIG. 2 is an illustration of an example visitor screening with integrated authorization (e.g., ticketing, credential verification) process 200 using a system that includes the inspection system 105 and two beacons 110. An individual (and in the illustrated example, a group of individuals, such as a family can be screened contemporaneously) enters the facility (e.g., venue). The individual has a device 205, such as a mobile device, that is capable of receiving a signal from a first beacon 110, which is located near the entrance of the facility (for example, in the parking lot). The device 205 receives the signal from the first beacon 110 and an application on the device 205 can, upon receiving the beacon signal, communicate with the remote server 115. The communication can be wireless such as over a cellular network. In some implementations, the device 205 can automatically display a credential for the individual to access the facility. For example, the credential can include a pre-purchased ticket.

In some implementations, the device can communicate with the remote server 115 and provide identity credentials to authenticate the individual's identity. The remote server 115 can, upon validating the individual's identity, determine whether the individual is authorized to access the facility (e.g., has previously purchased a ticket to the event).

In some implementations, once the identity of the individual is determined, the system can identify or determine additional information associated with the individual, which can be useful for screening and authorization. For example, the individual may have a pre-clearance status, a very important person (VIP) status, and the like. In addition, the person may have a physical need or characteristic that would affect the screening process. For example, the person may have a metal implant (e.g., replacement hip) that requires a special screening process, may have medical or other special needs that allow for an individual to bring an item that may otherwise be considered contraband (e.g., medicine, a medical device, and the like). This additional information can be stored or accessed by the remote server 115.

As the individual approaches the checkpoint, their device 205 receives a signal from a second beacon 110 located at the checkpoint. When the device 205 receives the signal, indicating that the individual is approaching the checkpoint, the remote server 115 can provide a message to a device of a ticket taker 210. The message can include a notice that the individual is (or is not) authorized to enter the facility and further can include any additional information about the individual, such as pre-clearance status, VIP status, or special screening requirements. In some implementations, the individual can provide the credential generated by their device 205 to ticket taker 210 and a message is not required to be sent to the ticket taker. The individual can then proceed through the security checkpoint and inspection process.

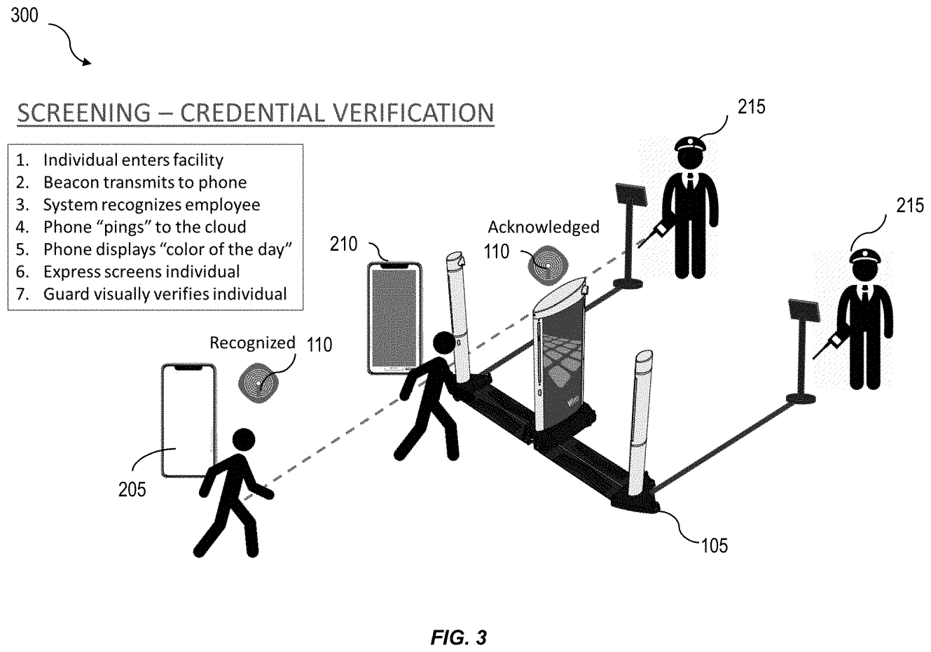

FIG. 3 illustrates another example process diagram of an example visitor screening with integrated authorization process 300. In this example, the credential that is displayed on the individual's device 205 can be provided or indicated by the remote server 115 and is not predetermined (e.g., as a ticket printed on paper is predetermined). Instead, the credential that is displayed on the individual's device 205 as the individual approaches the checkpoint can include a code or other indicator that is known to the security screeners 215 to be a validated credential. For example, at any given moment, a color may be considered a valid credential and thus the screener will allow the individual displaying the valid color to pass. The color can change based on a number of factors and/or time periods. For example the valid color may change daily such that there may be a “color of the day”. In some implementations, the period may be shorter than a day, for example, the color may be valid for an hour, a minute, a few seconds, or the like. In some implementations, the frequency of indicator change can be dynamic (e.g., change). In the implementation where the period of time a given value changes frequently (e.g., on the order of seconds or minutes), a display can be provided to the security screener to indicate the presently valid color. Because in some implantations of the current subject matter the valid color can change (and the change may be determined randomly) and unlike credential printed on paper, the current subject matter can provide for a system whereby the credentials can be more difficult (if not impossible) to forge.

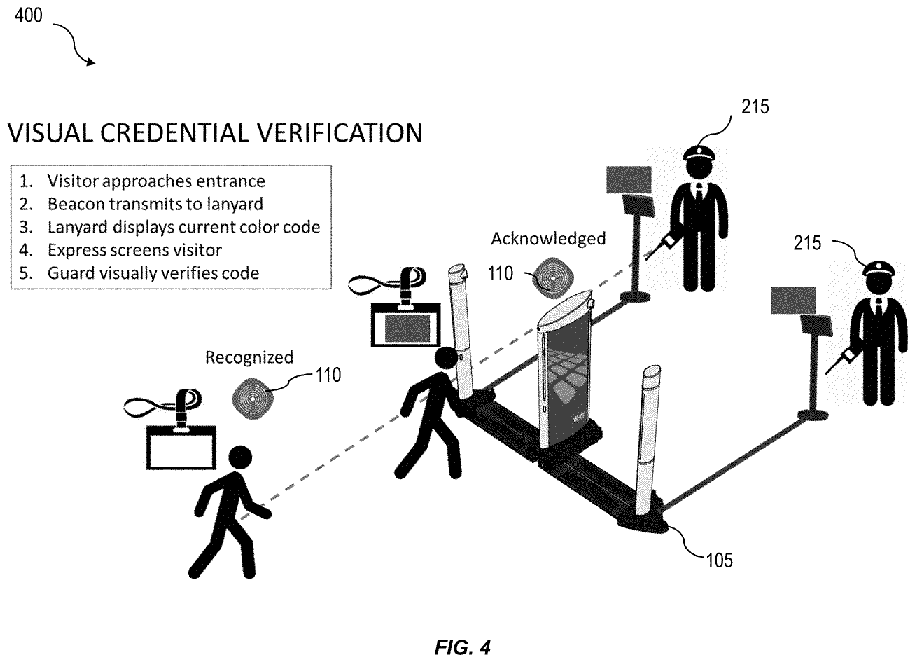

FIG. 4 is another example process diagram of an example visitor screening with integrated authorization process 400. In the illustrated example, the individual's device can be a low-cost device carried in a lanyard. Example low-cost devices that can be carried in a lanyard include devices provided by Beaconstac (of New York, N.Y., USA) or by Kontakt.io (of New York, N.Y., USA).

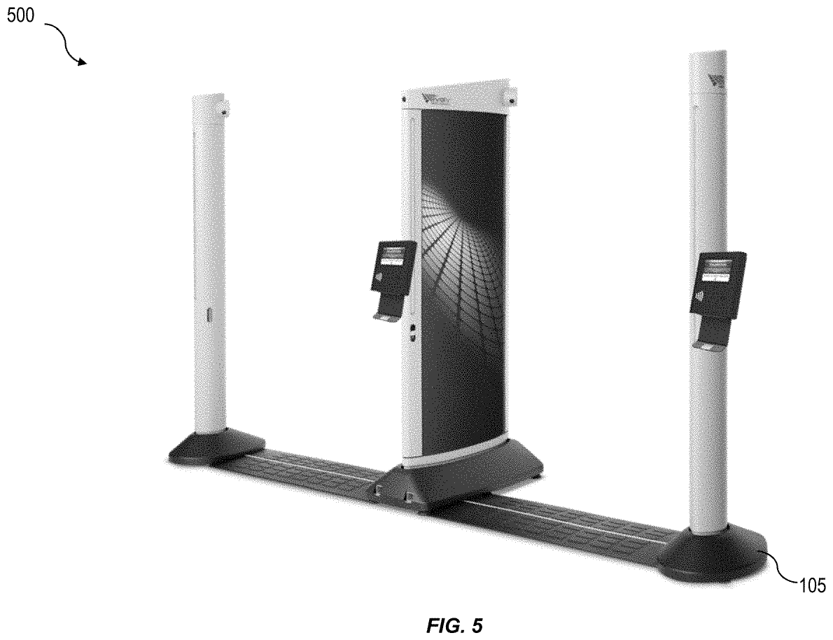

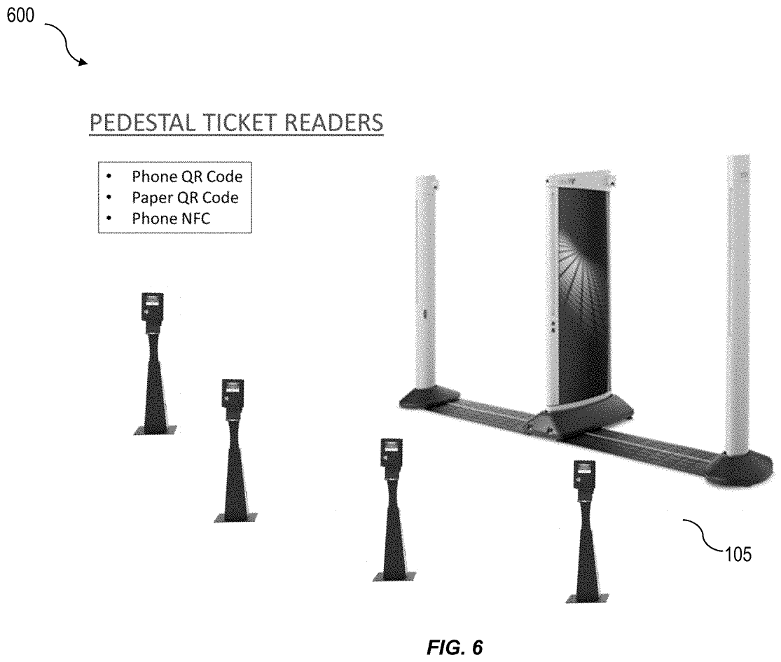

FIGS. 5-6 illustrate an example of a digital detection system 100 including an inspection system 105 with sensors 110 other than a beacon. The sensors can include a barcode reader, QR code reader, NFC, Bluetooth, or other sensor that allows an individual to present (e.g., swipe) their credential. The system can indicate to the screener that the individual's credentials are (or are not) verified and the individual is (or is not) authorized to proceed. The sensors can be located proximate to the inspection system 105, or separate, for example, along an approach to the inspection system 105.

Some implementations of the current subject matter can utilize an improved personnel inspection system, which in some example implementations, can be capable of performing threat detection and discrimination in high clutter environments in which individuals may be carrying personal items such as cell phones and laptops and without personal item divestment. In some implementations, a personnel inspection system can perform threat detection and discrimination with high throughput that allows individuals to pass through the detector at normal walking speeds such that individuals are not required to slow down for inspection and, in some implementations, the inspection threshold can allow for multiple individuals to pass through the threshold side-by-side (e.g., two or more abreast).

Advantages of this improved personnel inspection system can include higher throughput of individuals being evaluated, reduced incidence of false alarms due to more accurate discrimination of metal objects as threats or non-threats, and reduced stress levels and improved emotional response for individuals being evaluated using the improved personnel inspection system. In addition, the improved personnel inspection system can more accurately distinguish metal objects present on an individual passing through the improved inspection system as threats or non-threats without requiring the individual to remove the metal object from their body. The data that is collected, processed, and generated by the improved inspection system can also be used within the context of other security-focused operations such as notification to system operators of individuals who are in possession of a detected threat object, training exercises for inspection system operators or supervisors, as well overall process improvement of security procedures which may occur prior to or after individuals are screened or evaluated using the improved inspection system.

Some example implementations of the improved inspection system can include a continuous-wave magnetic detection system of high sensitivity, capable of detecting disturbances in its transmitted field of up to one part in 10,000. To facilitate this sensitivity, the system can be configured to transmit a stable magnetic field and to measure the transmitted magnetic field using a low-noise method, as magnetic disturbances caused by unintentional system noise can be very difficult to distinguish from magnetic disturbances caused by metallic objects. In this context, system noise can encompass a number of signal interferences, including traditional electronic noise, amplitude variations in the transmitted magnetic field, and/or digital error, which can be introduced by harmonic mismatches between intentional signals and sampling rates associated with analog to digital conversion.

Some example implementations can include an active magnetic system that can acquire a series of magnetic field measurements of an observational domain; determine in-phase and quadrature components of the magnetic field measurements; determine a measure of polarizability (e.g., a polarizability tensor, polarizability index) of an object in the observational domain; localize the object including determining speed, position, and time offset of the object; and perform threat detection and/or discrimination of the object in the presence of clutter using the magnetic field measurements, the polarizability, and/or the localization information. In some implementations, the system can be configured to detect for firearms and/or improvised explosive devices (IEDs).

In some implementations, the system can determine a polarizability of objects under inspection and can perform threat detection and discrimination (e.g., classification) using the polarizability of the objects. By determining and utilizing the polarizability of objects, certain threats, such as fire arms and improvised explosive devices, can be more accurately detected, resulting in improved personnel inspection systems.

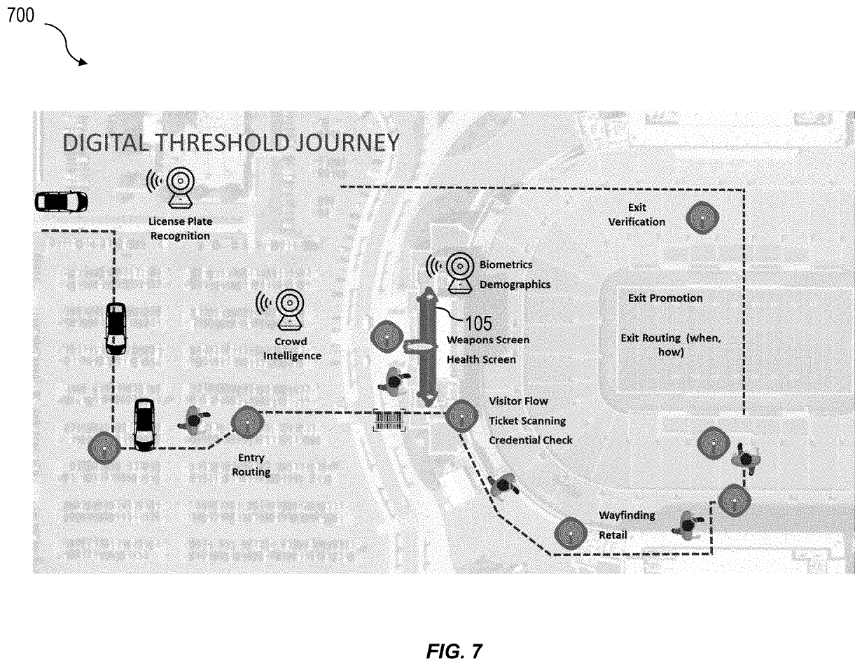

FIG. 7 illustrates the path of an individual through a facility 700 (e.g., stadium) during a typical visit and further illustrates how some implementations of the current subject matter can streamline the individual's visit from approach to exit. The facility 700 includes multiple sensors 110 throughout the facility including at the approach to the parking lot, within the parking lot, at the approach to the building (e.g., stadium), at the checkpoint (as described above), and within the building.

As the individual approaches the parking lot, a smart camera can identify the license plate of the individual's car. The license plate can be used to identify the individual and that the individual is approaching the parking lot. Within the parking lot, a beacon can provide a signal to the individual's device, which can communicate with the remote server. Because use of the beacon makes the system location-aware, the remote server can provide messages that are contextually relevant to the individual. For example, the remote server can indicate which section of the parking lot has free parking spaces, the optimal route to the entrance of the building, which entrance to use where there are more than one entrances, and the like.

Additional smart cameras can be utilized for crowd intelligence, biometrics, and demographic information. This information can be utilized by the system, for example, to aid in crowd control and screening.

The individual can be routed to an appropriate entrance and undergo an integrated authorization and security screening process, for example, as described in more detail above. In some implementations, the screening can include a health screening (e.g., temperature check).

Once the individual has passed through the checkpoint including security screening and authorization (e.g., ticket scanning, credential check, and the like), beacons within the facility can enable additional location-aware functionality including wayfinding. For example, with knowledge that the individual is in a certain location, the remote server 115 can provide messages to the individual's device including optimal routes to retail, seating sections, and the like. The routes can be optimized based, for example, on crowd intelligence to efficiently balance the flow of people through the facility. Similarly, once the event is over, the system can provide messages to the individual's device including optimal routes to the exit. In some implementations, the system can verify when the individual has left.

Although a few variations have been described in detail above, other modifications or additions are possible. For example, the current subject matter can utilize different technologies to enable location-awareness. For example, devices utilizing global positioning system (GPS), Wi-Fi, and beacons (utilizing various wireless technology) can be used.

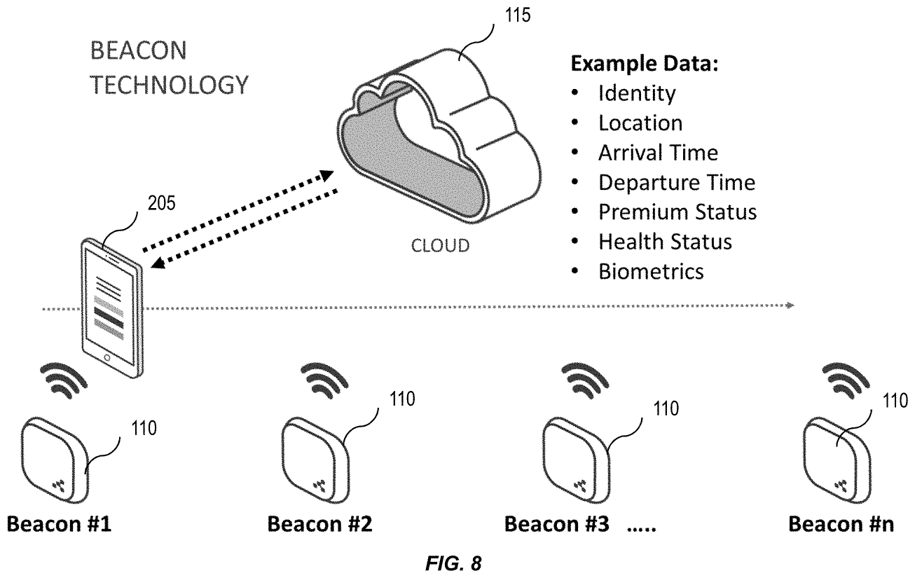

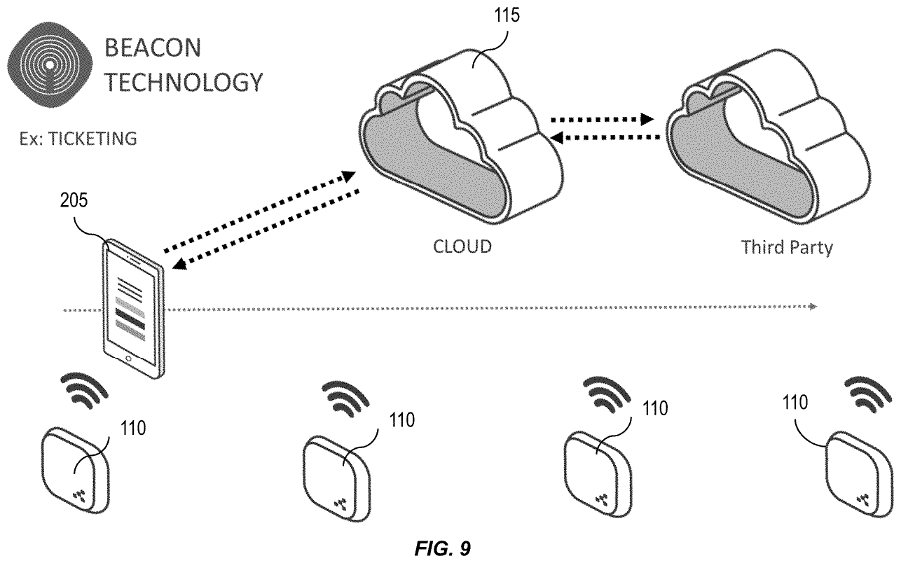

FIGS. 8-9 illustrate data flow between various sensors, devices (e.g., mobile devices), remote server 115, and third party services. The third party services can include, for example, ticketing services that can be utilized to determine whether an individual has purchased a ticket to an event. Other third party services can be used.

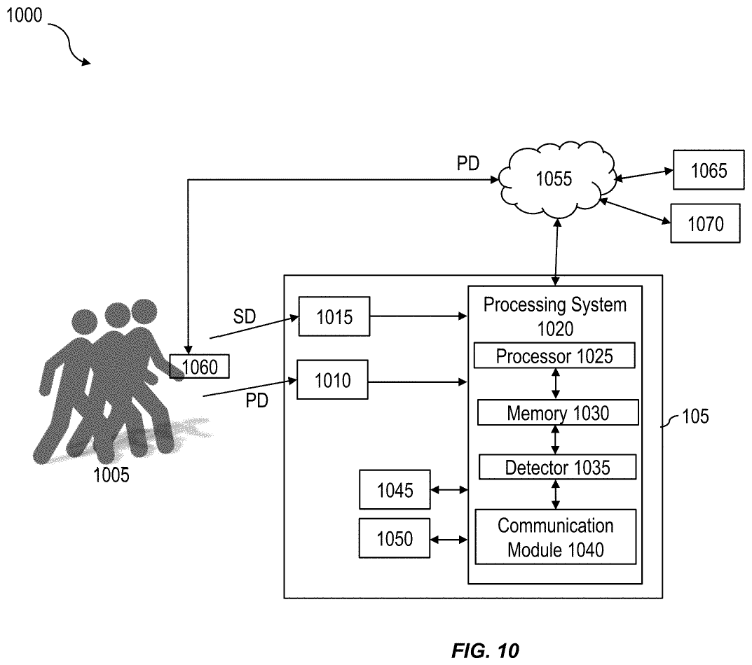

FIG. 10 is a system block diagram of an embodiment of a digital threshold system 1000 including an inspection system 105 for identifying an object or individual based on proximity data. As shown in FIG. 10 an individual 1005 (or an object 1005) can approach or be presented in proximity with a sensor 1010 and a sensor 1015 arranged within an inspection system, which can correspond to the inspection system 105 described in relation to FIG. 1. The digital threshold system 1000 can correspond to the inspection system 100 described in relation to FIG. 1.

An individual or object 1005 can travel or be brought into proximity of a proximity sensor 1010. The sensor 1010 can have a sensor range or field of view in which proximity data can be acquired from individuals or objects 1005 passing through a geographic area forming the field of view. In some embodiments, a plurality of individuals 1005 can travel into proximity of the sensor 1010. For example, a digital threshold can be located at an entrance to a venue, and the geographic area forming the proximity field of view can include a room within a building, such as a lobby. Thus individuals entering the lobby can be considered within the geographic area. In some embodiments, the sensor 1010 can include at least one of an infrared camera, a thermal camera, an ultrasonic distance sensor, a video camera, an electro-optical camera, a surface map camera, a depth map camera, a short range wireless data transmission sensor (e.g., a Bluetooth receiver, near-field communication (NFC) receiver, and the like), a radio frequency identification reader, and/or a barcode reader.

An individual 1005 can have in their possession or carry a computing device 1060, such as a personal electronic device, a smartphone, or similar computing device configured to exchange data with a network, such as network 1055. Proximity data (PD) can be acquired by the sensor 1010 and provided to the processing system 1020. The proximity sensor 1010 can be triggered as the person or object 1005 approaches the sensor 1010 (e.g., enters the geographic area, such as entering the lobby of a venue). In some embodiments, the PD can be generated by a personal electronic device (PED) 1060, such a cell phone, smart phone, or similar mobile computing device. The PD can include a unique identifier (UID) associated with an individual carrying the PED 1060. The PD can be associated with a single individual 1005 or a plurality of individuals 1005. In some embodiments, the PD can be received by the processing system 1020 via the network 1055 in advance of or before PD is received via the sensor 1010. In some embodiments, the individual 1005 can register with the system 1000 via the PED 1060 and the identity of the individual 1005 can be stored in the database 1065 and later provided to the processing system 1020 for identity determination and/or security authorization. In this way, individuals 1005 can register their identity (and their PED 1006) as known and trusted users or devices of the system 1000.

In some embodiments, the UIDs can include data that is pre-generated and can be pre-assigned to an individual. For example, an employee badge number, a customer ID, a transaction ID, or a digital code such as a code associated with a digital ticket providing entrance to an event Another UID example can include a confirmation code that is assigned to an airline travel passenger. The UID can be associated with the individual who is traveling on multiple flights.

In some embodiments, the PD can include a collection of UIDs that can be associated with a plurality of individuals. For example, each individual UID in the aforementioned collection of UIDs can be assigned to a group of individuals, such as a family, a team, or a similar collection of individuals. The UID can also be an account number, a confirmation code, or a reservation ID that can be assigned to one or more individuals in the group. The UID can be assigned during a registration process performed at a prior date or time. Another example can include UIDs associated with an account number of a cellular data plan that is shared among members of a family or business unit.

In some embodiments, the UID can be associated with the PED 1060. For example, the PED UID can be an international mobile equipment identity (IMEI) number of the PED. The IMEI is a unique 15-digit code that precisely identifies the device with the SIM card input. The first 14 digits are defined by GSM Association organization. The last digit is generated by an algorithm named the Luhn formula and it has a control character. The IMEI number is an individual number assigned to each and every phone all over the world. The IMEI number can be provided based on Bluetooth functionality enabled on the PED 1060. In some embodiments, the proximity sensor 1010 can be a Bluetooth sensor configured to receive the IMEI via Bluetooth communication protocols. In some embodiments, a collection of PED UID can be associated with a plurality of PEDs in the possession of the plurality of individuals. The allocation of an IMEI number to a device is handled by an allocation authority. A collection of PEDs can be associated with a collection of IMEIs. Each IMEI in the collection of IMEIs can be respectively assigned to each PED in the collection of PEDs by the allocation authority.

IMEIs are typically sent with cellular data communications. However, IMEIs may not be automatically sent for Bluetooth communications, although in some cases they are transmitted via Bluetooth communications. Commonly, Bluetooth communications transmit a media access control (MAC) address. The MAC address can include a unique identifier assigned to a network interface controller (NIC) for use as a network address in communications within a network segment. Other communication protocols including Ethernet, and Wi-Fi, also use MAC addresses. MAC addresses are recognizable as six groups of two hexadecimal digits, separated by hyphens, colons, or without a separator. MAC addresses are primarily assigned by PED manufacturers, and are often hard coded as an Ethernet hardware address, a hardware address, or a physical address. Each address can be stored in hardware, such as the PED's memory, or by a firmware mechanism. MAC addresses can also include a manufacturer's organizationally unique identifier (OUI). The detection of the UID can depend on the type of proximity sensor that is configured to detect the PD.

In some embodiments, the PD can include a one-time use token or a collection of tokens generated via a tokenization method or process. UlDs, PED UlDs, or token data can be acquired simultaneously for a plurality of individuals or objects 1005. Tokens can be a non-sensitive identifier that can map back to a sensitive data element. Tokens can be generated via random number generators and token mapping tables. Tokens can be similar to a key that can be de-tokenized to map back to particular sensitive data. In some embodiments, the digital threshold system 1000 may not include a proximity sensor 1010 and the PD can include an arrival time window of the individual or object 1005 within a viewable domain of the PD sensor 1010.

In the example of PD data associated with an arrival time or time window, an individual can be expected to arrive at the facial recognition system described herein at a specific time or a particular time window. The arrival time window can be used in place of the PD to reduce a size of a gallery used in the facial recognition system. For example, the gallery can be pre-filtered based on the current time of day to only include individuals that are expected to arrive at the arrival time or within the arrival time window. For example, if individual A was expected to arrive on a specific day between 10 AM-11 AM, the gallery can be pre-filtered based on this information so that the gallery would not include this individual before 10 AM or after 11 AM on the specific day. The arrival time window can be a pre-negotiated time of arrival similar to a reservation for an event or at a restaurant. In some embodiments, the arrival time window can be a time that is communicated via data received from a PED, such as time included in a text, voice, or data message.

The digital threshold system 1000 can also include sensor 1015 configured to capture sensor data (SD) associated with the individual or object 1005. In some embodiments, the sensor 1015 can capture SD associated with a plurality of individuals 1005. For example, the SD can include biometric data, such as an image of the individuals face or image data of the object 1005. In some implementations, biometric data can include an embedding vector (e.g., a facial feature vector). In some embodiments, the SD can include biometric data as fingerprint data, such as fingerprints acquired via a fingerprint scanner device 1015. The sensor 1015 can include an RGB camera, a black and white camera, an infrared (IR) camera, a thermal camera, am ultrasonic distance sensor, a video camera, an electro-optical (EO) camera, and/or a surface/depth map camera. Sensor 1015 creates image data or video data of a scene in which the object or individual 1005 is present. In some implementations, sensor 1015 transmits images or video to processing system 1020 for further analysis. System 1000 can include multiple sensors 1015. In some implementations, sensor 1015 can include a radio frequency identification (RFID) reader. The SD can be associated with a single individual 1005 or a plurality of individuals 1005.

The SD and PD can be provided to the processing system 1020 in order to determine the identification of the individual or object 1005. The use of the PD can enable faster processing and more accurate identity determination than using SD alone. The processing system 1020 can include a processor 1025, a memory 1030, a detector module 1035, a communications module 1040, a display 1045, an input device 1050, and a database 1065. In some embodiments, the database 1065 can be configured within the memory 1030.

The processor 1025 can be configured to execute instructions stored in the memory 1030 (and/or the database 1065) determine identity of one or more individuals. Responsive to executing the instructions, the processor 1025 can cause the detector module 1035 to receive PD and to query the database 1065 for a subset of individuals or objects 1005 who are associated with the PD. The database 1065 can include identification data associated with a large population of individuals, for example a global gallery of individuals and objects 1005 and their associated UID, PED UID, or token data. The global gallery can also include identification data such as individual face images, fingerprints, embeddings (e.g., facial feature vectors), or other biometric data associated with an individual 1005. An embedding can be a vector that can mathematically represent characteristics and properties of a face. Embedding vectors can be used by the facial recognition algorithms to compute distances and similarity scores used for matching purposes.

The detector module 1035 can receive the query results including the subset of individuals or objects 1005 can further receive SD for the subset of individuals or objects 1005. The detector module 1035 can compare the query results for the subset of individuals or objects 1005 received from the database 1045 with the SD acquired for the same subset of individuals or objects 1005 to determine if the identities of the subset of individuals or objects 1005 associated with the PD match the identities of the subset of individuals or objects 1005 returned from the database 1065. In this way, the processing system 1020 can pre-filter the global gallery of individuals or objects 1005 in the database 1065 for identification and/or matching purposes. Advantageously, filtering to a smaller subset of candidates for matching and comparison can enable fasting matching speed because of a reduced number of computations needed (e.g., smaller sample size to be searched in the database 1065) and also reduce the risk of false matching while increasing the confidence in the outputs of the detector module 1035.

In some embodiments, the detector module 1035 can determine an identity of the individual 1005 and/or a security authorization of the individual 1005. For example, the detector module 1035 can be configured with computer-executable instructions which implement identification protocols and/or authorization protocols associated with a security status of an individual. The instructions can control operation of the processing system 1020, such as the display 1045, in addition to controlling one or more sensors, such as the sensors 1010 and/or 1015, and actuated mechanical devices, such as actuated gates, turn-styles, or entry/exit barriers that can be included in the digital threshold system described herein. For example, the instructions can be configured to control identification and security authorization protocols or functionality of inspection system 105 or digital threshold system 1000.

The processing system 1020 can also include a communication module 1040, a display 1045 and an input device 1050. The communication module 1040 can be configured to transmit and receive data from other computing devices, which can be communicatively coupled to the processing system 1020. For example, a remote computing device can transmit and receive data with the processing system 1020 via the communication module 1040 for training or sensor calibration purposes. The outputs of the detector module 1035 can be provided via the display 1045. For example, the detector module 1035 can be configured to generate visible or audible alerts or notifications via the display 1045 responsive to determining a failed match condition between the individual or object 1005 for whom the PD was collected and the identity of the individual or object 1005 stored in the database 1065. Users can interact with the processing system 1020 via input device 1050 to provide various inputs associated with identity determination performed via the digital threshold system 1000.

In some embodiments, the digital threshold system 1000 can include a computing device 1070. For example, the computing device 1070 can include a server, or similar computing device including a processor, memory, and communication module to transmit and receive data via network 1055. In some embodiments, the computing device 1070 can be include a database of identification data associated with individuals 1005. In some embodiments, the computing device 1070 can be associated with a ticketing service and can include ticketing data related to the individuals 1005. In some embodiments, the computing device and/or the database 1065 can include algorithms configured to implement security or detection thresholds within the digital threshold system 1000. The algorithms can for example, be configured to control or operate one or more sensors, such as sensors 1010 and/or 1015. For example, the algorithms can be configured to control or adjust one or more operating parameters of the sensors 1010 or 1015, such as a field of view, alarm generation or status, notification generation or status, or the like.

The PED 1060, sensors 1010 and 1015, the computing device 1070, and the database 1065 can be coupled to the processing system 1020 via a network 1055. The network 1055 can include, for example, any one or more of a personal area network (PAN), a local area network (LAN), a campus area network (CAN), a metropolitan area network (MAN), a wide area network (WAN), a broadband network (BBN), the Internet, and the like. Further, the network can include, but is not limited to, any one or more of the following network topologies, including a bus network, a star network, a ring network, a mesh network, a star-bus network, tree or hierarchical network, and the like.

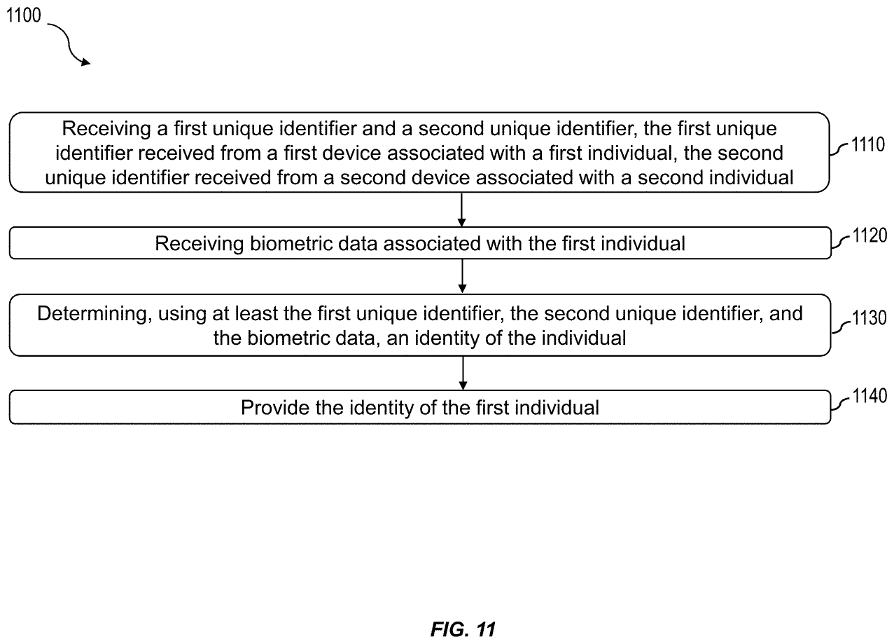

FIG. 11 is a process block diagram of an embodiment of a process 1100 for identifying an object or individual based on proximity data using the system of FIG. 10. As shown in FIG. 11, at 1110 a first unique identifier can be received from a first device associated with a first individual and a second unique identifier can be received from a second device associated with a second individual. The unique identifiers can be acquired as PD by the sensor 1010 and can characterize each of the individuals 1005. The PD can include UIDs, PED UIDs, or token data associate with an individual or a group of individuals. For example, the proximity data can include at least one of a unique identifier of the individual, a unique identifier associated with a personal electronic device of the individual, or token data associated with the individual. The unique identifier can associated with the personal electronic device of the individual can include an international mobile equipment identity number of the personal electronic device. The UID can include a media access control (MAC) address of a network interface card of the personal electronic device. In some embodiments, the proximity data can correspond to a time window at which the individual 1005 is expected to pass through the field of view of the sensor 1010.

At 1120, biometric data associated with the first individual can be received. For example, the sensor 1015 can include a camera configured to acquire image data of a face of the individual 1005 as the individual travels through a geographic area forming a field of view of the sensor 1015. In some implementations, the biometric data can include an embedding vector, which can be determined from an image of a face.

At 1130, an identity of an individual 1005 can be determined based on at least the first unique identifier, the second unique identifier, and the biometric data. For example, based on a UID associated with a PED 1060 of an individual 1005 acquired via sensor 1010 and a facial image of the individual 1005 acquired via sensor 1015, the system 1000 can determine an identity of the individual 1005.

In some embodiments, determining the identity of the individual can include filtering a database, such as the database 1065, using at least the first unique identifiers and the second unique identifier to generate a set of candidate identities. The database can include registered individuals, such as individuals 1005 who have used their PED 1060 to register their identity with the system 1000. The database can include associations of a registered identity, a registered unique identifier, and registered biometric data for individuals included in a larger population or dataset of individuals. The first plurality of individuals can be a subset of the larger population or dataset of individuals included in database. The database can be filtered based on a time window including a time, during which the first plurality of individuals are expected to be within the geographic area of the proximity sensor. For example, the database can be filtered for individuals scheduled to attend an event starting between two specific times or at one specific time. The use cases for such time-based filtering can include event scheduling applications for performances, sporting events, airline travel, or any similar time-based appointment for which identification verification and/or security authorization can be required.

The biometric data acquired by the sensor 1015 can be compared to the registered biometric data included in the database 1065 for at least one candidate identity included in the set of candidate identities. The comparing can include, for example, calculating a distance in feature vector space between the at least one candidate identity and the acquired biometric data (e.g., calculating a distance between the embedding vector of the at least one candidate and the acquired embedding vector).

Based on the comparing, the identity from the set of candidate identities can be selected. For example, based on affirmatively matching the acquired biometric data of an individual with the registered biometric data of the same individual, the identity of the individual can be confirmed. Selecting can occur, for example, based on a distance between an acquired embedding vector and a candidate embedding vector being less than a predetermined threshold, or according to another metric of similarity.

At 1140, the system 1000 can provide the identity of the first individual 1005 determined at 1130. In some embodiments, providing the identity of the first individual can include authorizing the first individual for access into a restricted area. For example, the first individual can be granted access into a venue. The authorizing can include accessing a credential associated with the identity and authorizing the credential. In some embodiments, accessing the credential can include requesting the credential from a ticketing system, such as computing device or server 1070.

In some embodiments, the identity can characterize a name of an individual 1005, a status of an individual 1005 such as a very important person (VIP) label, a person of interest status, a known law enforcement status, a health status, a medical condition, or an employment status. In some embodiments, the identity can also characterize an employee number, a membership number, a social security number, and/or a ticket number.

In some embodiments, providing the identity of the individual can include providing the identity in a security screening sensor system and modifying an operation of the security screening sensor system based on the determined identity. In some embodiments, the security screening sensor system can correspond to the digital threshold system 100 and 1000 respectively described in relation to FIGS. 1 and 10.

In some embodiments, modifying operation of the security screening system can include changing a detection threshold for detecting a threat passing through an entryway of the security screening sensor system, changing a threat classification algorithm, or changing a transmit or receive level of the security screening system. In some embodiments, the threat can include a firearm, a blade, an explosive, and/or a weapon. In some embodiments, the entryway can include an inspection system, such as inspection system 105 described in relation to FIGS. 1-7. In some embodiments, providing the identity of the individual 1005 can include unlocking a physical barrier, such as a gate present at an entry way to allow entry by the first individual to a restricted area. In some embodiments, a security status of an individual 1005 can be determined and the operation of the security screening system 100, 1000 can be modified based on the determined security status. For example, the security status of the first individual 1005 can indicate an increased likelihood the first individual will pass a security screening check or a decreased likelihood the first individual will pass the security screening check.

In some embodiments, providing the identity can include generating a visible alert in a display 1045 responsive to determining the biometric data of the individual 1005 fails to match the registered biometric data of the individual 1005. In some embodiments, providing the identity of the individual can include generating an audible alert responsive to determining the biometric data of the individual 1005 fails to match the registered biometric data of the individual 1005. In some embodiments, providing the identity of an individual can include providing an area or location map, such as a seating chart, showing a location of one or more identified individuals, each with unique security statuses as determined by the systems described herein.

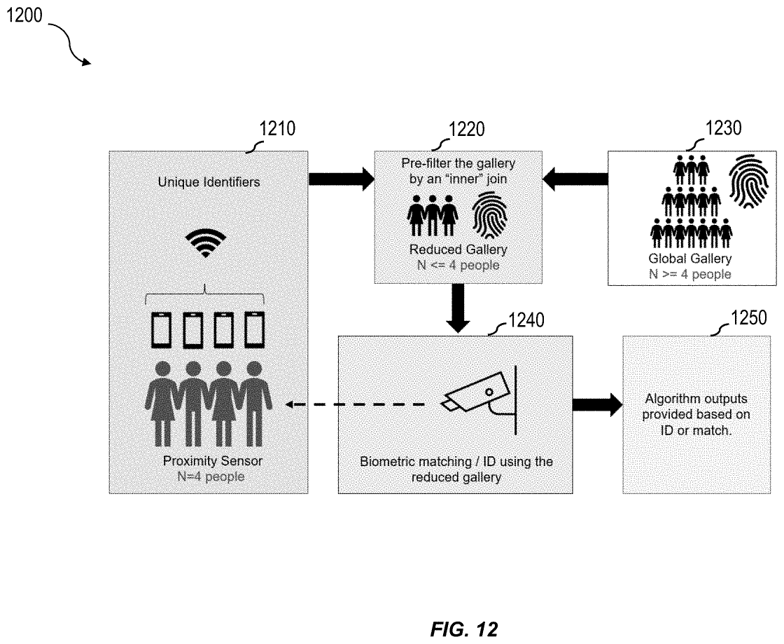

FIG. 12 is a data flow diagram 1200 describing an example embodiment for identifying an object or individual based on proximity data using the system of FIG. 10 performing the process of FIG. 11. As shown in FIG. 12, at 1210, unique identifiers (or PD) associated with a group of 4 individuals can be retrieved. The unique identifiers can be PD that can include PED UIDs associated with a PED in the possession of each individual.

At 1220, the unique identifiers retrieved at 1210 can be used to determine a subset of three individuals for whom the unique identifiers match into the global gallery 1230. The global gallery 1230 can contain a large number of individuals (and can include the individuals for whom the unique identifiers were retrieved at 1210 (as well as the subset determined at 1220).

At 1240, the query results received from the database 1065 identifying the subset of 3 individuals can be compared by the detector module 1035 to the SD corresponding to initial group of four individuals (and thus, including the subset of the three individuals). At 1250, the detector module 1035 can determine and output an identity of the three individuals based on determining a match between the SD and the query results.

Exemplary technical effects of the subject matter described herein include the ability to determine identification of individuals or objects using proximity data or temporal data. In this way, a pre-filtered subset of candidate individuals or objects can be identified and a reduced query set can be provided to a database. Reducing the size of the query data can enable reduced numbers of data processing operations, generation of identity results more rapidly, more efficient use of available computing resources, and reduced incidence of false positive identity determinations. The subject matter described herein can also determine identification of individuals or objects using proximity data or temporal data. In this way, a pre-filtered subset of candidate individuals or objects can be identified and a reduced query set can be provided to a database. Reducing the size of the query data can enable reduced numbers of data processing operations, more rapid generation of identity results, more efficient use of available computing resources, and reduced incidence of false positive identity determinations.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving a first unique identifier and a second unique identifier, the first unique identifier received from a first device associated with a first individual, the second unique identifier received from a second device associated with a second individual;
receiving biometric data associated with the first individual;
determining an identity of the first individual, the determining the identity including
filtering a database using at least the first unique identifier and the second unique identifier to generate a set of candidate identities, the database associating a registered identity, a registered unique identifier, and registered biometric data for each of a second plurality of individuals, wherein the first plurality of individuals form a part of the second plurality of individuals,
comparing the received biometric data to the registered biometric data of at least one candidate identity in the set of candidate identities, and
selecting, based on the comparing, the identity from the set of candidate identities; and
providing the identity of the first individual.

2. The method of claim 1, wherein the first unique identifier and the second unique identifier are received by a proximity sensor having a sensor range characterizing a geographic area, wherein the first individual and the second individual form part of a first plurality of individuals, the first plurality of individuals being within the geographic area.

3. The method of claim 2, wherein the proximity sensor includes an infrared camera, a thermal camera, an ultrasonic distance sensor, a video camera, an electro-optical camera, a surface map camera, a depth map camera, a short range wireless data transmission sensor, a radio frequency identification reader, and/or a barcode reader.

4. The method of claim 1, further comprising:
filtering the database based on a time window characterizing a time that the first plurality of individuals are expected to be within the geographic area of the proximity sensor.

5. The method of claim 1, wherein the first unique identifier includes a unique identifier associated with a computing device of the individual, an international mobile equipment identity number of the computing device, a media access control address of a network interface card of the computing device, and/or a token associated with the individual and generated by the computing device.

6. The method of claim 1, wherein the biometric data characterizes a facial image or a fingerprint.

7. The method of claim 1, wherein the providing the identity includes authorizing, using the determined identity, the first individual for access into a restricted area,
the authorizing including accessing a credential associated with the identity and authorizing the credential.

8. The method of claim 7, wherein accessing the credential includes requesting the credential from a ticketing system.

9. The method of claim 1, wherein providing the identity includes providing the identity to a security screening sensor system and modifying operation of the security screening sensor system based on the determined identity,
wherein the security screening system includes:
an entryway;
at least one transmitter configured to transmit radar signals and/or a magnetic field to interrogate objects and/or people passing through the entryway;
at least one sensor configured to receive radar signals and/or measure the magnetic field; and
a data processor configured to receive data characterizing the received radar signals and/or measured magnetic field and determine a threat level associated with the object and/or person passing through the entryway.

10. The method of claim 9, wherein modifying operation of the security screening system includes changing a detection threshold for detecting a threat passing through the entryway, changing a threat classification algorithm, changing a transmit or receive level of the security screening system, wherein the threat includes a firearm, a blade, an explosive, and/or a weapon.

11. The method of claim 9, further comprising determining a security status of the first individual and modifying operation of the security screening system based on the determined security status, the security status of the first individual indicating an increased likelihood the first individual will pass a security screening check or a decreased likelihood the first individual will pass the security screening check.

12. The method of claim 1, wherein the identity characterizes: a name, a very important person (VIP) label, a person of interest status, a known law enforcement status, an employee number, a membership number, a social security number, and/or a ticket number.

13. The method of claim 1, wherein the providing the identity includes unlocking a gate to enable entry by the first individual to a restricted area.

14. A system comprising:
a memory storing computer-executable instructions; and
a data processor communicatively coupled to the memory and configured to execute the computer-executable instructions stored in the memory, which when executed cause the data processor to perform operations including
receiving a first unique identifier and a second unique identifier, the first unique identifier received from a first device associated with a first individual, the second unique identifier received from a second device associated with a second individual;
receiving biometric data associated with the first individual;
determining an identity of the first individual, the determining the identity including
filtering a database using at least the first unique identifier and the second unique identifier to generate a set of candidate identities, the database associating a registered identity, a registered unique identifier, and registered biometric data for each of a second plurality of individuals, wherein the first plurality of individuals form a part of the second plurality of individuals,
comparing the received biometric data to the registered biometric data of at least one candidate identity in the set of candidate identities, and
selecting, based on the comparing, the identity from the set of candidate identities; and
providing the identity of the first individual.

15. The system of claim 14, wherein the first unique identifier and the second unique identifier are received by a proximity sensor having a sensor range characterizing a geographic area, wherein the first individual and the second individual form part of a first plurality of individuals, the first plurality of individuals being within the geographic area.

16. The system of claim 15, wherein the proximity sensor includes an infrared camera, a thermal camera, an ultrasonic distance sensor, a video camera, an electro-optical camera, a surface map camera, a depth map camera, a short range wireless data transmission sensor, a radio frequency identification reader, and/or a barcode reader.

17. The system of claim 14, wherein the instructions further cause the data processor to perform operations comprising:
filtering the database based on a time window characterizing a time that the first plurality of individuals are expected to be within the geographic area of the proximity sensor.

18. The system of claim 14, wherein the first unique identifier includes a unique identifier associated with a computing device of the individual, an international mobile equipment identity number of the computing device, a media access control address of a network interface card of the computing device, and/or a token associated with the individual and generated by the computing device.

19. The system of claim 14, wherein the biometric data characterizes a facial image or a fingerprint.

20. The system of claim 14, wherein the instructions for providing the identity further cause the data processor to perform operations comprising:
authorizing, using the determined identity, the first individual for access into a restricted area, the authorizing including accessing a credential associated with the identity and authorizing the credential.

21. The system of claim 20, wherein accessing the credential includes requesting the credential from a ticketing system.

22. The system of claim 14, wherein the instructions for providing the identity further cause the data processor to perform operation comprising providing the identity to a security screening sensor system and modifying operation of the security screening sensor system based on the determined identity, wherein the security screening system includes:
an entryway;
at least one transmitter configured to transmit radar signals and/or a magnetic field to interrogate objects and/or people passing through the entryway;
at least one sensor configured to receive radar signals and/or measure the magnetic field; and
a data processor configured to receive data characterizing the received radar signals and/or measured magnetic field and determine a threat level associated with the object and/or person passing through the entryway.

23. The system of claim 22, wherein the instructions for modifying operation of the security screening system cause the data processor to perform operations comprising:
changing a detection threshold for detecting a threat passing through the entryway, changing a threat classification algorithm, changing a transmit or receive level of the security screening system, wherein the threat includes a firearm, a blade, an explosive, and/or a weapon.

24. The system of claim 22, wherein the instructions further cause the data processor to perform operations comprising:
determining a security status of the first individual, and
modifying operation of the security screening system based on the determined security status, the security status of the first individual indicating an increased likelihood the first individual will pass a security screening check or a decreased likelihood the first individual will pass the security screening check.

25. The system of claim 14, wherein the identity characterizes: a name, a very important person (VIP) label, a person of interest status, a known law enforcement status, an employee number, a membership number, a social security number, and/or a ticket number.

26. The system of claim 14, wherein the instructions for providing the identity further cause the data processor to perform operations comprising
unlocking a gate to enable entry by the first individual to a restricted area.

27. A computer-readable medium storing computer-executable instructions, which when executed by a data processor cause the data processor to perform operations comprising:
receiving a first unique identifier and a second unique identifier, the first unique identifier received from a first device associated with a first individual, the second unique identifier received from a second device associated with a second individual;
receiving biometric data associated with the first individual;
determining an identity of the first individual, the determining the identity including
filtering a database using at least the first unique identifier and the second unique identifier to generate a set of candidate identities, the database associating a registered identity, a registered unique identifier, and registered biometric data for each of a second plurality of individuals, wherein the first plurality of individuals form a part of the second plurality of individuals,
comparing the received biometric data to the registered biometric data of at least one candidate identity in the set of candidate identities, and
selecting, based on the comparing, the identity from the set of candidate identities; and
providing the identity of the first individual.
